(19) United States
(12) Patent Application Publication
(10) Pub. No.: US 2012/0178344 A1
(43) Pub. Date: Jul. 12, 2012

(54) Conforming Band to a Designated Object

(76) Inventor: Maria D'Anza, Chester, NJ (US)

(21) Appl. No.: 13/376,230

(22) PCT Filed: Jun. 11, 2010
(86) PCT No.: PCT/US2010/038260

§ 371 Date: Feb. 4, 2012

Related U.S. Application Data
(60) Provisional application No. 61/186,345, filed on Jun. 11, 2009.

(51) Int. Cl. A41C 1/08; B32B 3/10; A41D 1/00

(52) U.S. Cl. 450/95; 2/69; 428/58

(57) ABSTRACT

This invention details a novel band having an expansion zone which will afford self-adjusting expansion when activated by an object which it surrounds. In apparel, the wearer is provided with an expandable size, tip-over and hip adhesion to accommodate comfortably an expanding stomach, such as a pregnant woman.

### CROSS REFERENCE TO RELATED APPLICATIONS

This application claims priority under 35 U.S.C. 119(e) to U.S. Provisional Application No. 61/186,345 filed Jun. 11, 2009, incorporated herein in its entirety.

### FIELD OF THE INVENTION

The invention is directed to an adjusting band.

### BACKGROUND OF THE INVENTION

Maternity clothes currently on the market provide fit by means of an elastic panel, placed in the garment such that it stretches and cradles the growing abdominal area of the pregnant woman. This elastic section is restrictive, and uncomfortable to wear as it squeezes and compresses the lower abdominal region. Having this section made out of elastic offers a number of problems to the wearer. First and foremost is the contact of elastic over the skin which can irritate sensitive skin. Secondly the elastic must be covered in order to have any resemblance of fashion.

Another negative attribute of the elastic expansion panel, is that it is worn such that it covers the wearers belly button or slightly higher. The elastic is then stretched over the expanding abdomen causing the waistband to fit too snuggly and the belly to be squeezed in the elastic sack. This elastic expansion panel must be covered by another portion of the garment or by a loose fitting blouse or top. Therefore it is difficult for professional women to maintain a formal attire without the look of a tent.

“Cinching” in the top of the Waistband is the primary strategy in today's mainstream offerings. Example- drawstring pants or elastics only in the very top inch of the Waistband and in some cases it requires the wearer to button and unbutton contraptions for expansion/contraction. This “cinching” technology is significantly flawed because when one gains weight or subsequently loses weight it is not just in one's waist measurement; the fluctuations are generally in the waist, high hip, hip and low hip region. These other cinching methods expand 1-2″; however our Invention expands from 0″-10″+. The process of “Cinching” is just in the waist; therefore the “cinching” effect leaves a demand in the market for our Invention.

A void exists in apparel for applications to individuals with stomach and back medical issues. These medical scenarios range from a recent “C-section” incision, IVF injection treatments, or endometriosis problems, to the young athlete who injured their back and can not wear constricting clothing. Current offerings for garments that addresses these medical clothing needs is not sufficient. Current offerings are focused on the age 65 “plus” crowd, mirror the “cinching” offerings noted above, and from a fashion perspective younger consumers have fewer, if any options from a fit, function and fashion perspective.

There still exists today the need for a form fitting garment with an expandable waistband that will be comfortable to wear all day, keep your bottoms from sliding down, and yet will offer fashion. The ability to wear a suit or pants set before, during and after pregnancy would be an added benefit. The following invention will describe such a waistband that can be incorporated into any article of clothing.

### BRIEF SUMMARY OF THE INVENTION

In a first embodiment, the invention is directed to a conforming band to a designated object having at least one connection section having a first end and second end and

at least one expansion zone attached to the at least one connection section.

In another embodiment, the invention is directed to an article of clothing ideally suited for use as a waistband in garments of clothing for men, women and children. The waistband is comfortable, discreet and has the ability to stretch and conform to the waist and body shape in the entire pelvic region (sometimes referred to as “the mid-section”) of a body; herein identified as the region of one's natural waist, waist, high hip, hip and low hip (“natural waist” defined as the circumference around the body front and back, level with the body's belly button; “waist” being defined as the circumference around the body front and back level with the top of the hip bones, high hip 2″ below the waist measurement, hip 4″ below the waist meansurement and low hip 6″ below the waist meansurement). The Invention is of great value when applied to (1) maternity clothing, affording an ideal fit before, during and after pregnancy, (2) clothing that can accommodate weight fluctuations for men, women and children, and (3) individuals who have medical issues with their mid-section, primarily, stomach and back. In all instances, the design of the waistband offers a high level of comfort, style and fashion in a conforming band to a body having at least one connection section and at least one expansion zone attached to the at least one connection section.

### BRIEF DESCRIPTION OF THE DRAWINGS

FIG. 1 is a front partial view of a V-shaped expansion zone in the non-activated/non-expanded position;

FIG. 2 is a front partial view of a V-shaped expansion zone in the activated/expanded position;

FIG. 3 is a side view of an article of clothing illustrating multiple V-shaped expansion zones in the non-activated/non-expanded position;

FIG. 4 is a side view of the article of clothing of FIG. 3, illustrating the V-shaped expansion zone in the activated/expanded position; and

FIG. 5 is a partial back view of an article of clothing illustrating a V-shaped expansion zone in the non-activated/non-expanded position.

### DETAILED DESCRIPTION OF THE INVENTION

Certain terminology is used herein for convenience only and is not to be taken as a limitation on the present invention. The terminology includes the words specifically mentioned, derivatives thereof and words of similar import. The embodiments discussed herein are not intended to be exhaustive or to limit the invention to the precise form disclosed. These embodiments are chosen and described to best explain the principle of the invention and its application and practical use and to enable others skilled in the art to best utilize the invention.

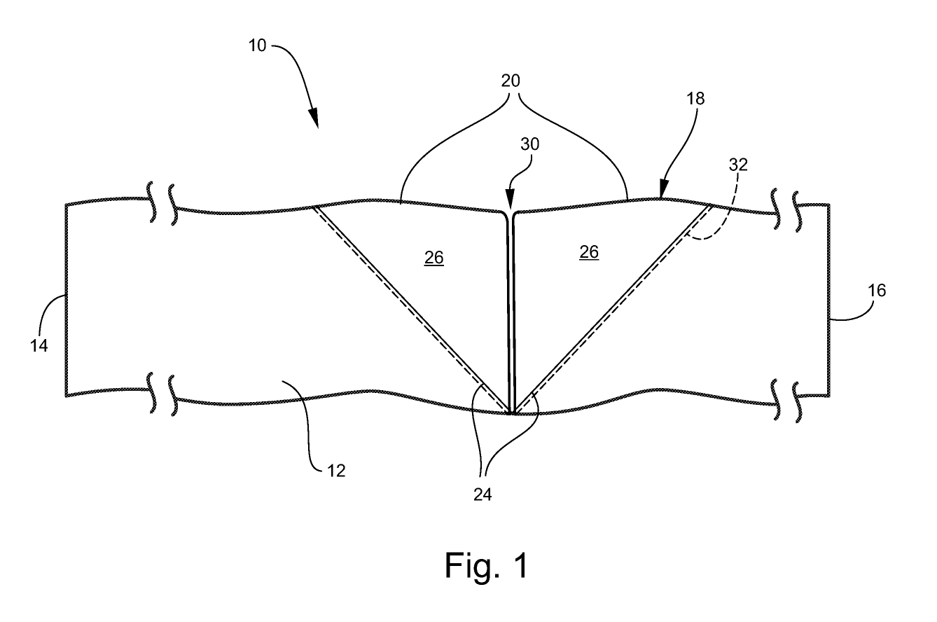

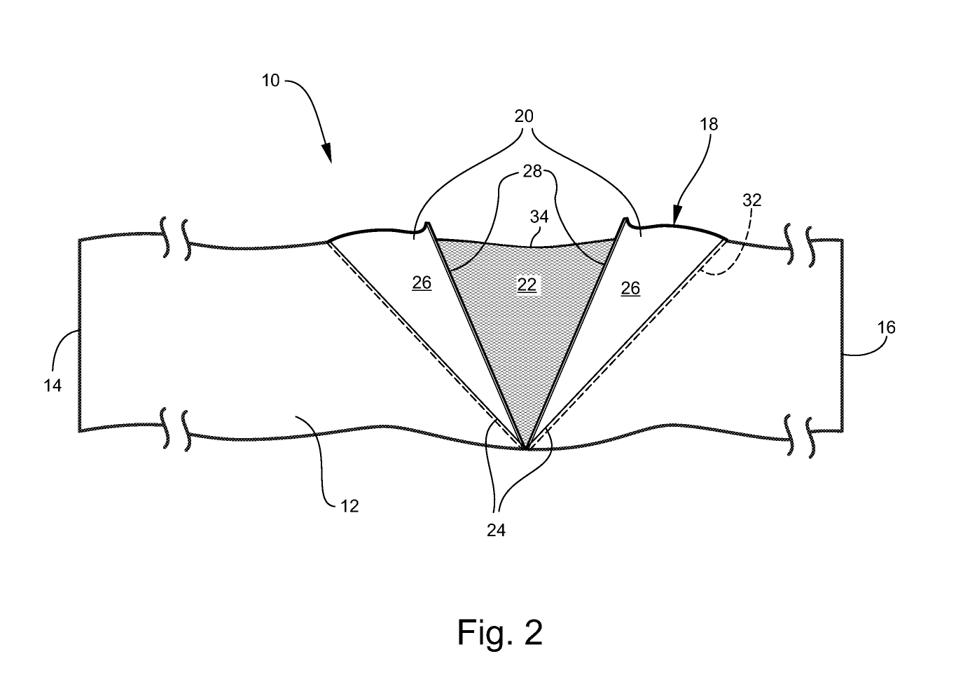

Referring to FIG. 1 and FIG. 2, in a first embodiment, the invention is directed to a conforming band 10 to a designated object having at least one connection section 12 having a first end 14 and second end 16 and at least one expansion zone 18 attached to the at least one connection section 12.

The expansion zone 18 is V-shaped which is critical to the invention to allow the defined function. Specifically, the “V” needs to be symmetrical but could vary a few degrees and still be effective. Symmetry is the key to why the invention functions properly because (1) symmetry maintains the elastic invisible within the expansion zone when expansion is not required and (2) allows expansion in the band evenly to the left and right of the zone without negatively affecting the band itself. For example, if the expansion zone is a square, while unexpanded there would not be an issue, however, when force required expansion, the bottom of the square would have to be stitched to a garment (or other contact material) and therefore expansion would not be a possibility and would disrupt the band by bunching “the garment” and losing shape. The “symmetrical shape” of the expansion zones allow them to work in concert along the band while the addition of expansion zones increase the amount of expansion and tip over of the band. No matter the number of expansion zones along the band,so as long as the expansion zones are aligned as defined herein, they do not work against each other. If all positioned in the front, then belly would have more expansion. If positioned equally around the garment, entire body expansion accommodated. If just in the back of the garment, the zones accommodate expansion in the back.

The expansion zone 18 has an exterior section 20 and a interior section 22, the interior section 22 and exterior section 20 are made of different material. As best illustrated in FIG. 2, when the expansion zone 18 is in the expanded or activated position, the exterior section 20 reveals the interior section 22. The interior section 22 is made of an elastic material or a material having elastic properties, most commonly nylon/polyester/spandex, allowing for expansion of the conforming band 10 when necessary to conform to an expanding object which it surrounds. The material of the exterior section 20 is most commonly same as the material of the at least one connection section 12; however it is recognized that the material of the connection section 12 and the exterior section 20 could be different if required for durability or fashion.

The exterior section 20 has a V-shaped border side 24 and a pair of extending portions 26 extending from the V-shaped border side 24. The extending portions 26 have a second side 28 and the V-shaped border side 24 is attached to the at least one connecting section 12. The second side of the pair of extending sides 28 extend central in the V-shaped expansion zone 18 defining a seam 30 substantially bisecting the V-shaped expansion zone 18 in the non-activated or non-extended position, best illustrated in FIG. 1. Further referring to FIG. 1, in the non-activated position, the interior section 22 is not visible as it is “hidden” by the pair of extending portions 26. The interior section 22 has a V-shaped periphery 32 (shown in phantom) which is complimentary and attached to the V-shaped border side 24 of the extending portions 26 attached to the at least one connecting section 12. However, those skilled in the art will appreciate that the V-shaped periphery can be continuous with further material within the connecting section 12 for ease in manufacture. Critical to this concept is that the V-shaped periphery and V-shaped border side is sewn to the at least one connecting section allow the defined function of the expansion zone 18. In this regard, a remaining periphery side 34 of the interior section 22 is not attached to the extending portions 26 of the exterior section 20. Thus, the extending portions 26 of the exterior section 20 do not interfere with movement of the interior section 22. This design increases the durability of the band based on the “layered” concept over current offerings on the market.. Specifically, the current maternity offerings, commonly remove the waistband entirely and replace it with a continuous elastic band that can be from approximately 2 to over 12 inches in height; which is usually unsightly and causes slipping. Further, such maternity offerings commonly tear at the contact point of the elastic band and the remainder of the garment after normal wear. The design of the present invention reduces or eliminates these problems.

The greatest width and greatest height of the V-shaped expansion zone 18 are related, more specifically, the related dimensions of the V-shaped expansion zone 18 must be recognized so as to allow proper function. The related dimensions must appreciate that the height and width (at their greatest value) should not exceed a difference of from about zero percent to about fifty (50%) with a most effective difference of about twenty-five percent (25%) This difference can be reduced to where the height and width (at their greatest value) can be approximately equal. Dimensions outside of this range will substantially affect the function of the V-shaped expansion zone 18. Most commonly, the height of the V-shaped expansion zone 18 will be dictated by the dimensions of the band as it is being used (as discussed in a separate embodiment herein). Further, one skilled in the art will appreciate if the expansion zones were positioned sideways whereas the bottom V point was horizontal and running parallel to the waistband, (< or >) this invention would not function. If the expansion zones were positioned wherein the bottom V point was at the top of the band this invention would not function. If the V was not symmetrical, function would be significantly reduced because equal expansion to the left and right of the center line would be achieved; which is critical to expansion around the entire circumference of the band.

The material of the interior section 22 can move in multiple directions allowing conforming to any object which “extends” the band 10. This property is derived from the elastic material required for the interior section 22 but is based on the design of the V-shaped expansion zone 18 and how its components are attached in conjunction with the connections section 12.

The invention will now be described in an additional embodiment wherein like reference numbers are meant to illustrate like features.

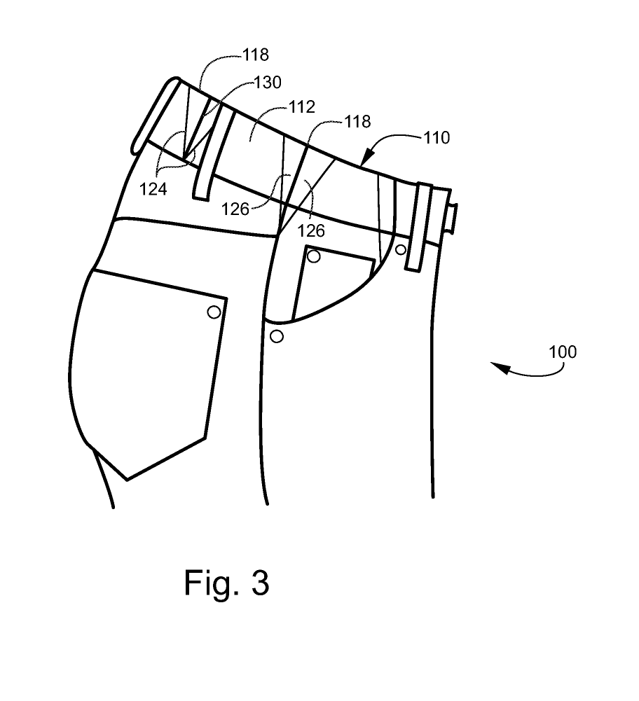

Referring to FIGS. 3, 4 and 5, in another embodiment, the invention is directed to a an article of clothing 100 having a conforming band 110 to a body having at least one connection section 112 having at least one expansion zone 118 attached to the at least one connection section 112. In this embodiment the article of clothing 100 is a pair of pants, wherein the conforming band 110 is located on the waistline of a body. It is understood by those skilled in the art the this present invention can be applied to various articles “or lines” of clothing including but not limited to, shirts, hats, blouses, athletic apparel, rehabilitation and other medical apparel, as well as various uses outside of apparel including but not limited to, pipe/tubing collars, diaper, training pants, girdles, undergarments, dog collars, shirt collars, lawn tools, balloons (medical, toys or entertainment), and medical devices.

As in the previous embodiment, at least one expansion zone 118 is V-shaped and has an exterior section 120 and a interior section 122, the interior section 122 and exterior section 120 being made of different material, wherein the material of the interior section 122 is elastic.

The pair of pants 100 has a front side 102A and a back side 102B, wherein the front side and back side have a plurality of two expansion zones 118X placed around the band 110. The activation of the expansion zones 118X on the front side 102B of the pants 102 by expansion of a body waistline directs pressure on the back side 102B against the body.

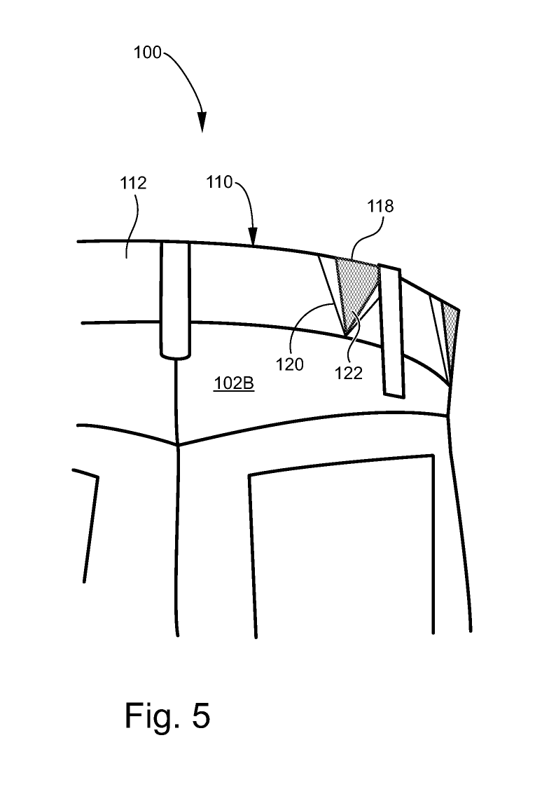

In addition to being able to expand, the shape of the expansion zones 118X becomes critical as this “V shape” will allow, for example, a waistband to develop “tip-over” This feature allows the top of the waistband of the pants 100 to not only stretch but to conform to the lower abdomen. This is accomplished by allowing the front of the waistband to tilt forward from about 0 degrees to about 180 degree, most commonly from about 0 degrees to about 90 degrees. It will be understood by those skilled in the art, the size and position of the expansion zones will control the amount of expansion of the waistband of the pants 100 as best illustrated in FIG. 5 in the present embodiment and the overall tip-over of the waistband, as well as anchor the waist band around the backside to prevent the garment from slipping down. For proper expansion and tip-over the waistband of this invention will have at least 2 expansion zones in, for example, the front side of a pair of pants (not shown). However, it is within the invention to contain from 2 to about 16 of these expansion zones.

As previously discussed, the size of the expansion zone will also control the amount of expansion and “tip-over.” The present invention can utilize expansion zones of virtually any size, for practicality the expansion zones will be from about one inch to about six inches tall (measured from the bottom of the V to a line between the top two arms of the “V”). By way of example, in clothing pants (U.S. size 4), the expansion zones are either 1.5 inches in height by 1.5 inches in width when not expanded; and on the hips the expansion zones are 4 inches height by 3 inches in width when not expanded. By further example, in skirts (U.S. size 4) the waistband is 2 inches high so the expansion zones in the front and back of the garment measure 2 inches in height by 1.5 inches width when not expanded.

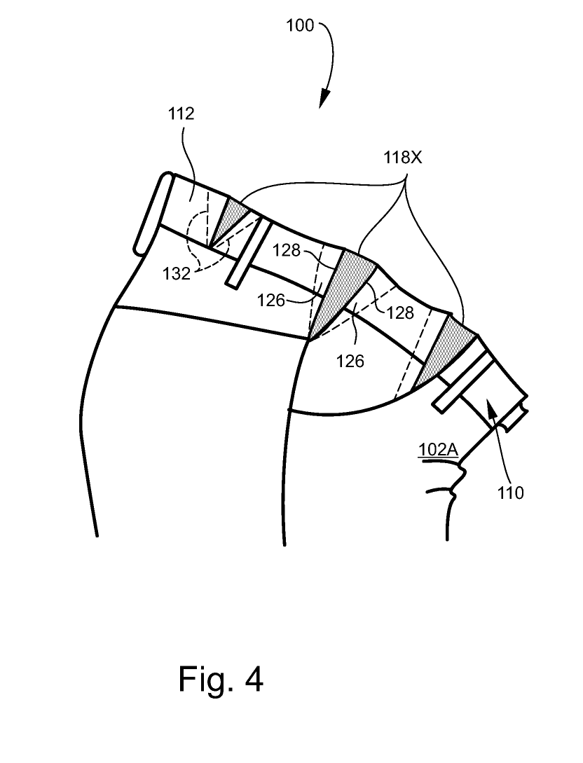

The positioning of the expansion zones will control the ratio of tip-over to expansion. For example, if all the expansion zones are placed near the side of the slacks, the tip-over angle will be much greater at full expansion, than if the zones are placed at the front and back of the slacks. Therefore, it is recognized the expansion zones can be placed equally distant around the waistband or have one expansion zone in the back and three along each side (for a total of 7) or have none in the front and back and three (3) along each side, spaced evenly from the rear pocket to the front pocket, as best illustrated in FIGS. 3 and 4. Core to the concept of a fashionable article of the clothing; the band, or in this embodiment, a waistband in a pair of pants, does not cause “bagging” or “unsightly folds” which would deter the wearing of an article of clothing incorporating the band of the present invention

As in the previous embodiment the basic structure of the invention is the same, the exterior section 122 has a V-shaped border side 124 and a pair of extending portions 126 extending from the V-shaped border side 124. The extending portions 126 have a second side 128, wherein the V-shaped border side 124 is attached to the at least one connecting section 112. The second side of the pair of extending sides 128 extends central in the V-shaped expansion zone 118 defining a seam 130 substantially bisecting the V-shaped expansion zone 118. The interior section 122 has a V-shaped periphery 132 (shown in phantom) which is complimentary and attached to the V-shaped border side 124 of the extending portions 126 attached to the at least one connecting section 112.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

What is claimed is:

1. A conforming band to a designated object comprising:
a. at least one connection section having a first end and second end; and
b. at least one expansion zone attached to the at least one connection section.

2. The band of claim 1, wherein the expansion zone is V-shaped.

3. The band of claim 2, wherein the expansion zone has an exterior section and a interior section, the interior section and exterior section made of different material.

4. The band of claim 3, wherein the material of the interior section is of elastic properties.

5. The band of claim 4, wherein the material of the exterior section is the same as the material of the at least one connection section.

6. The band of claim 5, wherein the exterior section has a V-shaped border side and a pair of extending portions extending from the V-shaped border side, wherein the extending portions have a second side, wherein the V-shaped border side is attached to the at least one connecting section, wherein the second side of the pair of extending sides extend central in the V-shaped expansion zone defining a seam substantially bisecting the V-shaped expansion zone.

7. The band of claim 6, wherein the interior section has a V-shaped periphery which is complimentary and attached to the V-shaped border side of the extending portions attached to the at least one connecting section.

8. The band of claim 7, wherein the V-shaped periphery and V-shaped border side is sewn to the at least one connecting section.

9. The band of claim 8, wherein a remaining periphery side of the interior section is not attached to the extending portions of the exterior section.

10. The band of claim 9, wherein the greatest width and greatest height of the V-shaped expansion zone are proportional.

11. The band of claim 10, wherein the material of the interior section can move in multiple directions.

12. An article of clothing having a conforming band to a body comprising:
a. at least one connection section; and
b. at least one expansion zone attached to the at least one connection section.

13. The article of clothing of claim 12, wherein the article of clothing is a pair of pants, wherein the conforming band is located on the waistline of a body.

14. The article of clothing of the claim 13, wherein the at least one expansion zone is V-shaped.

15. The article of clothing of claim 14, wherein the at least one expansion zone has an exterior section and a interior section, the interior section and exterior section made of different material.

16. The article of clothing of claim 15, wherein the material of the interior section is elastic.

17. The article of clothing of claim 16, wherein the exterior section has a V-shaped border side and a pair of extending portions extending from the V-shaped border side, wherein the extending portions have a second side, wherein the V-shaped border side is attached to the at least one connecting section, wherein the second side of the pair of extending sides extend central in the V-shaped expansion zone defining a seam substantially bisecting the V-shaped expansion zone.

18. The article of clothing of claim 17, wherein the interior section has a V-shaped periphery which is complimentary and attached to the V-shaped border side of the extending portions attached to the at least one connecting section.

19. The article of clothing of claim 18, wherein the pair of pants has a front side and a back side, wherein the front side has two expansion zones on the front side and no expansion zones on the back side, wherein activation of the expansion zones on the front side of the pants by expansion of a body waistline directs pressure on the back side against the body.

20. The article of clothing of claim 18, wherein the pair of pants has a plurality of expansion zones place around the connection section.
